(19) United States
(12) Patent Application Publication
(10) Pub. No.: US 2008/0042996 A1
(43) Pub. Date: Feb. 21, 2008

(54) Touch panel with a transparent electrically conductive polymer film and manufacturing process

(75) Inventors: Michiko Endo, Shinagawa (JP); Takashi Nakajima, Shinagawa (JP); Koji Nishimura, Shinagawa (JP); Norio Endo, Shinagawa (JP)

Correspondence Address: STAAS & HALSEY LLP, SUITE 700, 1201 NEW YORK AVENUE, N.W., WASHINGTON, DC, 20005, US

(73) Assignee: FUJITSU COMPONENT LIMITED, Tokyo (JP)

(21) Appl. No.: 11/783,869

(22) Filed: Apr. 12, 2007

(30) Foreign Application Priority Data
Aug. 21, 2006 (JP) 2006-224103

(51) Int. Cl. G06F 3/041

(52) U.S. Cl. 345/176

(57) ABSTRACT

A touch panel according to the present invention is constructed such that a transparent substrate coated with a transparent electrically conductive film and having dot spacers formed on top thereof, and a polarizing plate coated with a transparent electrically conductive polymer on a side thereof facing the transparent substrate, are disposed opposite each other with a prescribed space provided therebetween. As a result, the manufacturing process of the touch panel having such a polarizing plate is greatly simplified and a transparent electrically conductive film having an excellent mechanical strength can be formed as the transparent electrically conductive film of the touch panel.

### FIELD OF THE INVENTION

The present invention relates to a resistive film type touch panel and, more particularly, to a touch panel having a polarizing plate coated with a transparent electrically conductive polymer and a manufacturing process.

### BACKGROUND OF THE INVENTION

Many types of touch panels are known which include the resistive film type (analog resistive film type), ultrasonic surface acoustic wave type, infrared interruption type, capacitive type, electromagnetic induction type, and image recognition type, and each type has its own advantages.

Among these types, the present invention employs the resistive film type. Because of its simple structure, simple circuit connections, and low cost, the resistive film type is widely used for touch panels; in fact, the majority of currently commercialized touch panels are based on this type.

FIG. 6 shows a cross section of a prior known resistive film type touch panel. In the figure, reference numeral 1 is the touch panel, 2 is a PET film, 3 is an upper ITO (Indium Tin Oxide) electrode, 4 is a glass substrate, 5 is a dot spacer, 6 is a lower ITO electrode, 7 is a double-sided adhesive tape, and 8 is a polarizing plate. The touch panel 1 comprises the glass substrate 4, the ITO electrode 6 formed on the glass substrate, the dot spacers 5 formed on the electrode, the PET sheet film 2 as an upper flexible substrate about 200 μm in thickness, and the polarizing plate 8 and ITO electrode 3 sandwiching the PET film therebetween. The spacers 5 are formed from an insulating material such as acrylate, urethane, or the like; the diameter of each dot spacer 5 is, for example, 50 μM, and the height is, for example, 5 μm to 6 μm. The ITO electrodes 3 and 6 are transparent electrodes, and are formed over the entire area of the panel, i.e., over the lower surface of the PET film 2 and the upper surface of the glass substrate 4, respectively. This touch panel is described in Japanese Unexamined Patent Publication No. 2003-196029.

FIG. 6 shows a condition in which the panel surface is not pressed with a finger or a pen tip; in this condition, no current flows between the ITO electrodes 3 and 6 because the electrodes are separated by the spacers 5. FIG. 7 is a schematic cross-sectional view of the panel showing a condition in which the film surface is touched with a finger (or pen tip). In the figure, the pressing force causes the ITO electrodes 3 and 6 on the PET film 2 and the glass 4 to contact each other, and a current flows. At this time, the resistive voltage dividing ratio is measured on each of the ITO electrodes 3 and 6 on the glass surface and the film surface, respectively, and the pressed position is thus calculated. This basic prior known resistive film type touch panel is described in Fujikura Technical Report, No. 102, April 2002, pp. 42-46, as well as in Japanese Unexamined Patent Publication No. H07-84705.

FIG. 8 shows the principle of how the coordinate point (X, Y) of a touch is calculated. FIG. 8(a) is a schematic diagram showing how the X coordinate is detected. Voltage Vcc is applied in the X direction on the upper transparent substrate 2, and the resulting voltage is detected on the lower glass to calculate the X coordinate. Likewise, FIG. 8(b) is a schematic diagram showing how the Y coordinate is detected. Voltage Vcc is applied in the Y direction on the lower glass, and the resulting voltage is measured on the upper transparent substrate to calculate the Y coordinate.

Next, a manufacturing flow of the prior art touch panel will be briefly described with reference to FIG. 9. To outline the panel manufacturing flow, first the upper transparent substrate is fabricated, then the lower transparent substrate is fabricated, and the two substrates are bonded together to construct the panel. First, the fabrication flow of the upper transparent substrate will be described. Here, the upper transparent substrate is a flexible transparent substrate formed from a film having an electrode layer disposed on the top of the touch panel.

The upper transparent substrate is fabricated in accordance with the flow shown at the left in FIG. 9. First, ITO is deposited on a PET film in a high-temperature sputtering process using, for example, an atmosphere of about 100° C., and the thus processed PET film is prepared in the form of a roll (g1). The film is cut to a size suitable for working (g2). Next, annealing is performed to remove the curl of the film and also to promote the crystallization of the ITO (g3). Ag is printed to form an electrode pattern on the thus treated film (g4). Finally, the film is stamped out (g5), to complete the fabrication of the upper transparent substrate.

Next, the lower transparent substrate is fabricated in accordance with the flow shown at the right in FIG. 9. That is, a glass substrate or transparent resin substrate of a suitable size is prepared (h1) by depositing ITO thereon using such techniques as sputtering or vacuum evaporation, as in the above film. An insulating material (for example, acrylate or urethane) as a dot spacer material is deposited on the substrate by printing or photolithography (h2), and then a resist is printed thereon (h3). After that, Ag is printed to form an electrode pattern and a wiring pattern on the lower substrate (h4), and a resist is printed thereon to complete the fabrication of the lower transparent substrate.

The thus fabricated upper and lower transparent substrates are bonded together (j1). Next, scribe lines are cut in the substrate to break the substrate along the scribe lines (j2), and the panel is produced by cutting the substrate precisely along the scribe lines. An FPC (Flexible Printed Circuit) is connected to the thus produced panel (j3) and, if necessary, a polarizing plate is attached to the top of the panel (j4), after which a test is conducted to check whether the panel actually operates properly (j5).

In the prior art resistive film type touch panel, the transparent electrically conductive film is formed using a metal oxide film such as ITO, but the deposition of such a metal oxide film requires the use of high-temperature sputtering at 100° C. or more or a vacuum process such as vacuum evaporation. As a result, depositing such material on the film has involved the problems that the production cost is high, the manufacturing equipment is large, the processing time is long, and so on. On the other hand, the ITO film, which is formed by depositing a ceramic-like ITO thin film on a resin film, has had the shortcoming that, when stresses due to pressing, etc. are repeatedly applied, microcracks are produced, leading to a degradation of characteristics. That is, the ITO film has had the problem that not only is the production cost high, but the mechanical strength of the film is low. In view of this, Japanese Unexamined Patent Publication No. 2003-196029 proposes the use of an electrically conductive polymer as the transparent electrically conductive material to replace the ITO film.

Touch panels are often used in combination with LCDs. The touch panel is mounted on the LCD, and the ambient light entering the touch panel is reflected back and forth within the touch panel and leaks outside the panel. Since this leaking light interferes with the display produced on the LCD, the visibility of the LCD display screen behind the touch panel decreases.

In view of this, to enhance the visibility of the LCD display screen, a polarizing plate is mounted on the surface of the touch panel in order to prevent the reflected light from leaking outside. Many touch panels for high-end applications are equipped with such a polarizing plate.

FIG. 10 shows the structure of the polarizing plate 8. As shown in FIG. 10, the polarizing plate 8 comprises a transparent protective film layer 11 formed from TAC (triacetyl cellulose), a polarizing film layer 12 formed from PVA (polyvinyl alcohol), and a transparent protective film layer 13 formed from TAC.

The fabrication process of the polarizing plate 8 is as follows. First, the PVA 12 is impregnated with a polarizing material such as a dye, iodine, etc. and then the thus prepared PVA is uniaxially stretched, thereby orienting the molecules so as to exhibit dichroism, and the protective films of TAC are attached to both sides of the PVA to complete the fabrication of the polarizing plate.

### SUMMARY OF THE INVENTION

The prior art touch panel equipped with a polarizing plate has the problem that, as the polarizing plate is attached to the outermost surface of the panel, the overall thickness of the touch panel increases and the complexity of the manufacturing process also increases.

On the other hand, when forming a transparent electrically conductive film directly on the polarizing plate, there arises the problem that it is difficult to form a stable transparent electrically conductive film on the surface of the polarizing plate, because the heat resistance of the polarizing plate is usually inferior to that of the PET film or the like used as the base material of the transparent electrically conductive film in the touch panel and because other properties such as chemical resistance are also inferior.

An object of the present invention is to greatly simplify the manufacturing process of a polarizer-equipped touch panel while, at the same time, realizing a polarizing plate having a stable electrically conductive film and achieving the construction of a touch panel having excellent characteristics, by employing an electrically conductive organic polymer for the transparent electrically conductive film and by ingeniously improving the method of film deposition.

The above object is achieved by a touch panel constructed such that a transparent substrate coated with a transparent electrically conductive polymer and having dot spacers formed on top thereof and a polarizing plate coated with a transparent electrically conductive polymer on a side thereof facing the transparent substrate are disposed opposite each other with a prescribed space provided therebetween. According to a second mode of the present invention, the polarizing plate of the touch panel includes a phase retardation plate coated with a transparent electrically conductive polymer. According to a third mode of the present invention, there is provided a touch panel manufacturing process comprising the step of fabricating an upper transparent substrate by coating a polarizing plate with a transparent electrically conductive polymer. According to a fourth mode of the present invention, there is provided a touch panel manufacturing process comprising the steps of: coating a protective film with an electrically conductive polymer; and fabricating an upper transparent substrate by bonding the electrically conductive polymer-coated protective film, a polarizing film, and a protective film which is different from the polymer-coated protective film, one on top of another.

According to a fifth mode of the present invention, the touch panel manufacturing process of the third or fourth mode of the present invention further comprises the steps of: radiating an excimer laser over a protective film surface on which the electrically conductive polymer is to be applied by printing; and applying a coating of the electrically conductive polymer and, according to a sixth mode of the present invention, the touch panel manufacturing process of the third or fourth mode of the present invention further comprises the step of forming an undercoat with binder particles dispersed in a transparent resin, as a base treatment for forming the electrically conductive polymer.

According to the present invention, as the complex process of ITO evaporation in the manufacturing process is replaced by a simple process of electrically conductive polymer coating which can be performed in the atmosphere, the whole process can be accomplished by continuous processing using a large-area film. As a result, the production cost, the time required for the production, and the complexity of the production can be greatly reduced. Furthermore, as the electrically conductive polymer, which has plastic characteristics similar to those of the polarizing plate, is flexible and resistant to repeated bending, the life of the touch panel can be greatly extended.

In the prior art, an ITO film is formed on one surface of the PET film substrate, and the polarizer is attached to the other surface; on the other hand, in the present invention, as the PET film is omitted, the manufacturing process is greatly simplified.

### BRIEF DESCRIPTION OF THE DRAWINGS

The above object and features of the present invention will be more apparent from the following description of the preferred embodiment with reference to the accompanying drawings, wherein:

FIG. 1 is a schematic cross-sectional view of a touch panel according to a first embodiment of the present invention;

FIG. 2 is a diagram showing a manufacturing process flow for the touch panel of the present invention;

FIG. 3 is a schematic diagram showing an electrically conductive polymer coating device according to the present invention;

FIG. 4 is a diagram showing a protective film with an electrically conductive polymer film formed thereon;

FIG. 5 is a schematic cross-sectional view of a touch panel according to a second embodiment of the present invention;

FIG. 6 is a schematic cross-sectional view of a prior art resistive film type touch panel;

FIG. 7 is a schematic cross-sectional view showing a condition in which the prior art touch panel is pressed with a finger;

FIG. 8 is a diagram for explaining the principle of how the pressed point is detected in the resistive film type touch panel;

FIG. 9 is a diagram showing a manufacturing process flow for the prior art touch panel; and

FIG. 10 is a perspective view of a prior known polarizing plate.

### DETAILED DESCRIPTION OF THE PREFERRED EMBODIMENTS

In the prior art, the upper transparent substrate of the touch panel has been made up of polarizing plate 8, PET film 2, and transparent electrically conductive film 3, as previously shown in FIG. 6.

By contrast, the present invention provides a distinctive feature that eliminates the need for the PET film 3 and that allows the upper transparent substrate of the touch panel to be made up of the polarizing plate 8 and the transparent electrically conductive film 3. Embodiments of the present invention will be described below.

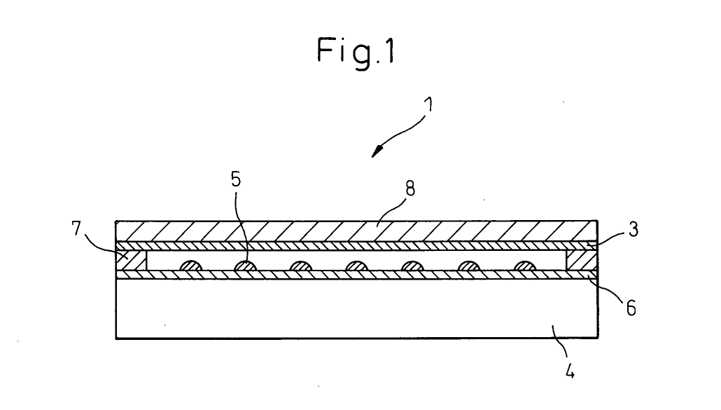

FIG. 1 is a schematic cross-sectional view of a resistive film type touch panel that uses a linear polarizing plate, according to a first embodiment of the present invention. In the figure, the same reference numerals as those used in the description of the prior art are used to designate the same component elements. That is, reference numeral 1 indicates the touch panel, and 3 the transparent electrode which is formed from an electrically conductive polymer. Further, reference numeral 4 indicates the glass substrate, 5 the spacers, and 6 the transparent electrically conductive film made of ITO. Reference numeral 7 indicates the double-sided adhesive tape, and 8 the polarizing plate.

In the present invention, the PET film 2 is omitted and, therefore, is not shown. The electrically conductive polymer layer 3 is formed to a thickness of 100 nm to 200 nm over the entire surface of the polarizing plate 8. The ITO 6 is deposited in the form of a film over the entire surface of the glass substrate 4.

In the present embodiment, glass coated with an ITO film having good transmissivity has been used as the lower transparent substrate but, alternatively, a glass substrate coated with an electrically conductive polymer as a transparent electrically conductive film or a transparent resin substrate coated with a transparent electrically conductive film such as ITO or an electrically conductive polymer may be used as the lower transparent substrate.

In the prior art, the upper transparent substrate has been constructed by disposing the polarizing plate 8 on one surface of the PET film and the ITO electrode on the lower surface thereof, as earlier described. On the other hand, the present inventors have devised a polarizing plate that eliminates the need for the PET film and that can, by itself, function as the upper transparent substrate, as described above. As a result, the manufacturing process for the PET can be omitted.

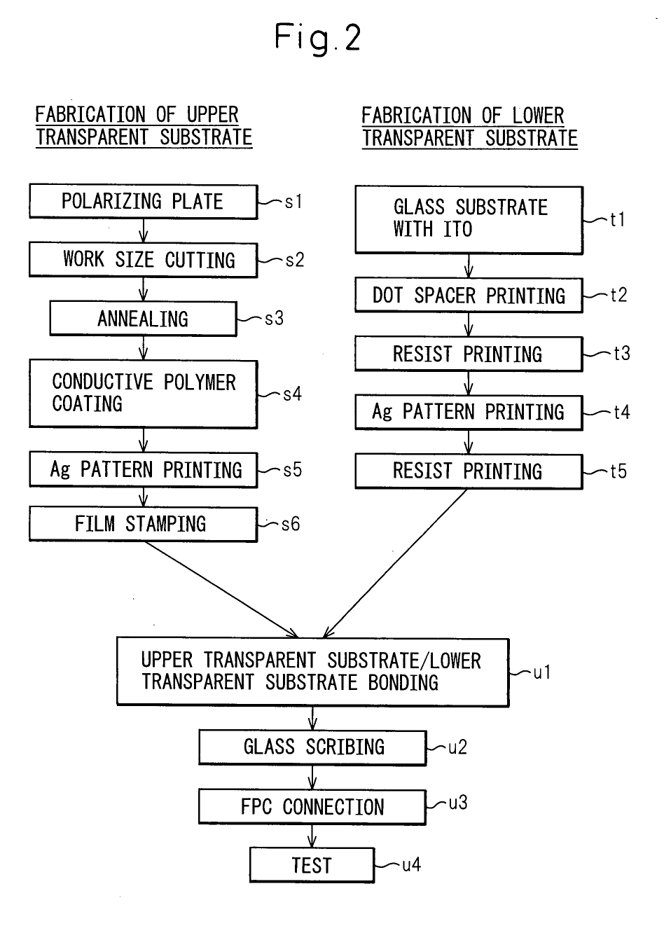

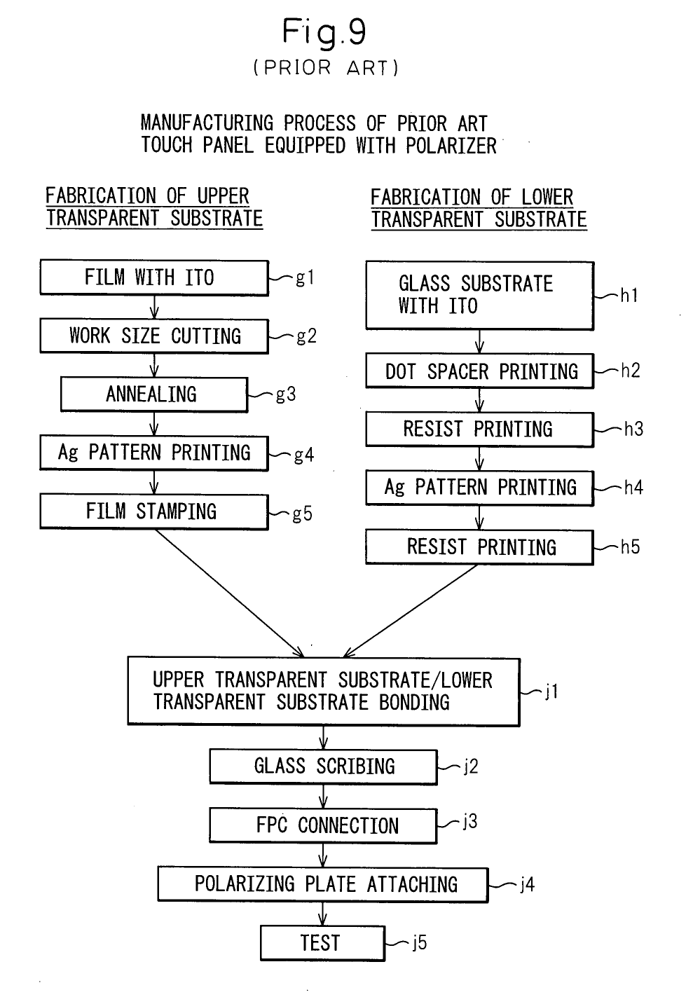

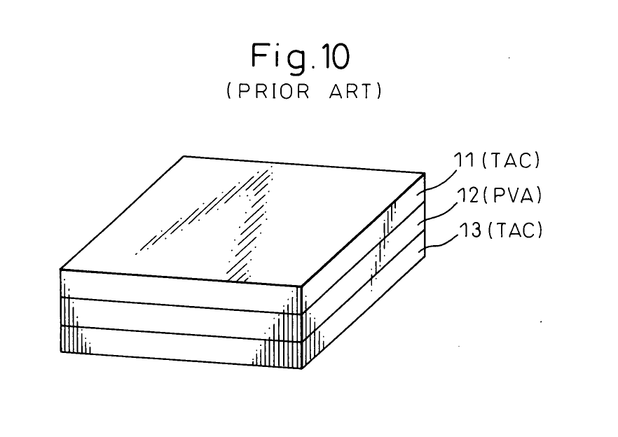

FIG. 2 is a diagram showing a manufacturing flow for the touch panel of the present invention. The panel fabrication flow is substantially the same as the prior art manufacturing flow (previously shown in FIG. 9). First, the upper transparent substrate is fabricated, after which the lower ITO electrode is evaporated to fabricate the glass substrate with the dot spacers formed thereon (the structure may hereinafter be referred to simply as the glass substrate), and the upper transparent substrate and the glass substrate are bonded together.

The upper transparent substrate is fabricated in accordance with a first fabrication process or a second fabrication process, as will be described below.

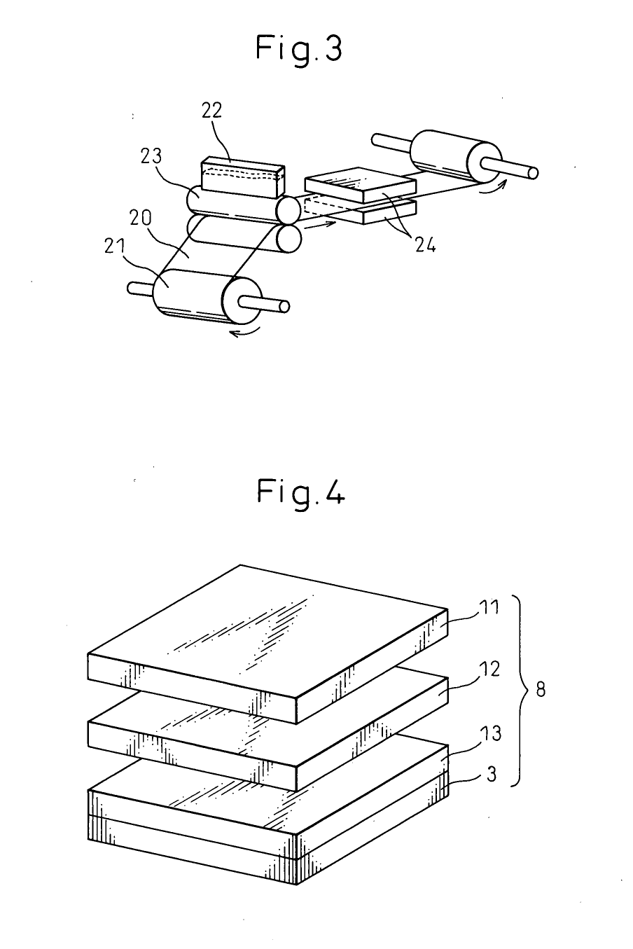

First, the first fabrication process will be described with reference to FIGS. 2 and 3. The first fabrication process is a method in which the electrically conductive polymer is applied after fabricating the polarizing plate. The fabrication flow of the upper transparent substrate is shown at the left in FIG. 2, and a description will be given below by referring to FIG. 2.

First, a multilayer film 20 consisting of three layers of TAC, PVA, and TAC that together form the polarizing plate is produced (s1), and the film is cut to a size manageable for working (work size) (s2). Next, annealing is performed to remove the curl and slack in the film (s3), after which the process proceeds to the electrically conductive polymer coating step (s4).

In step S4, the electrically conductive polymer is applied over the surface of the multilayer film 20. Bar coating, spray coating, screen printing, etc. can be used as the coating method, and portions where the electrically conductive film need not be formed may be covered with a mask so that the electrically conductive film can be formed only on the necessary portions. The film thickness of the thus applied electrically conductive polymer is 10 μm to 30 μm before drying. The resistance value of the transparent electrically conductive film, after drying at 100 to 120° C., is 400 to 900Ω/□.

A material such as polythiophene, polyaniline, or the like is used as the transparent electrically conductive polymer. Next, the multilayer film 20 coated with the electrically conductive polymer is dried in a drier 24 at 100 to 120° C. In this way, by applying the electrically conductive polymer in the form of a solution to the multilayer film 20 and drying the solution, the electrically conductive polymer film can be easily formed (s4).

Next, Ag is printed to form the electrode pattern on the film (s5). Finally, the film is stamped out to fit the size of the touch panel (26) to complete the fabrication of the upper transparent substrate. Here, it will be recognized that the metal material for forming the circuit pattern is not limited to Ag.

The second fabrication process is a method in which, after forming the transparent electrically conductive polymer film on the protective film TAC (of the polarizing film), the protective film TAC is bonded to the polarizing film PVA. A description will be given below by referring to FIGS. 3 and 4. The transparent electrically conductive polymer 3 is applied by printing on the protective film (TAC, cycloolefin, or the like) 13 of the polarizing film 12 by using a roll coater, a gravure coater, or the like, as shown in FIG. 3, and is dried at 100 to 120° C.

In this fabrication example, the film thickness of the electrically conductive polymer was 10 μm to 30 μm before drying, and the resistance value of the transparent electrically conductive film 3 after drying was 400 to 900Ω/□. Next, the protective film with the electrically conductive polymer printed thereon (13, 3) is bonded to one surface of the polarizing film 12, and the protective film 11 with no electrically conductive polymer printed thereon is bonded to the other surface of the polarizing film 12, to complete the fabrication of the polarizing plate 8 having the electrically conductive polymer layer formed thereon. The thus fabricated polarizing plate 8 is cut to a suitable work size, followed by annealing, Ag electrode pattern printing, and film stamping, to complete the fabrication of the upper transparent substrate (not shown).

Here, prior to the printing of the electrically conductive polymer 3, the surface of the protective film 13 on which the electrically conductive polymer is to be printed may be radiated with an excimer laser to activate the surface in order to enhance the adhesion of the electrically conductive polymer to the protective film 13; by so doing, a more stable electrically conductive polymer layer can be formed.

As an alternative method, if an undercoat formed by dispersing binder particles in a transparent resin is applied as a base treatment (easy adhesion layer) for the formation of the electrically conductive polymer, the adhesion of the electrically conductive polymer further improves, and a stable electrically conductive polymer layer 3 can be formed.

The fabrication process of the glass substrate is the same as the prior art flow and, therefore, will not be described here. As earlier described, a transparent resin substrate may be used instead of the glass substrate.

In the present embodiment, since the polarizing plate is already used in the film formation step, the polarizing plate attaching step (j4) after the FPC connection can be omitted from the prior art manufacturing process.

As described above, according to the present invention, since the PET film forming process is omitted from the manufacturing process, and since the electrically conductive polymer is applied to form the electrically conductive film, not only the production cost but the time required for the production and the complexity of the production can also be reduced.

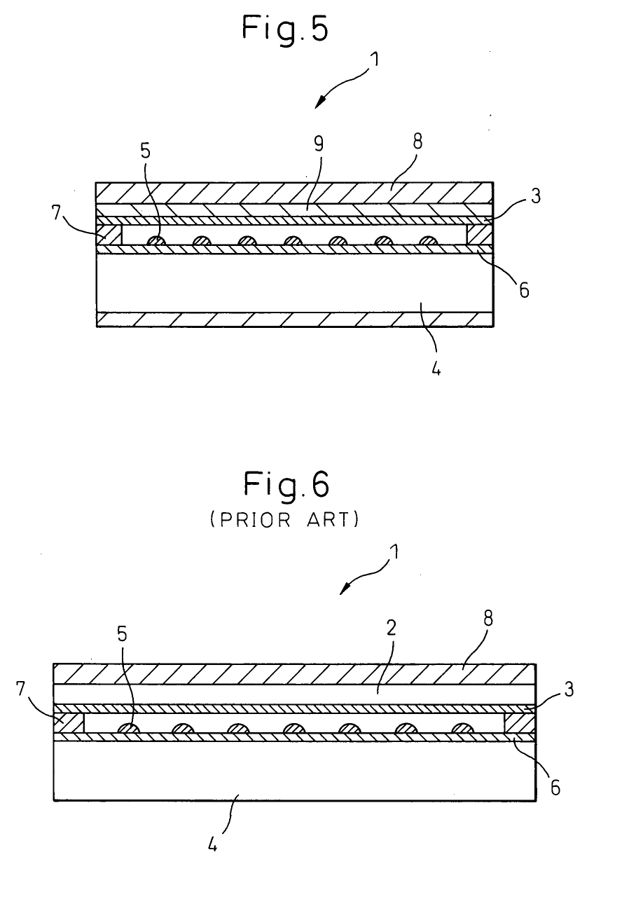

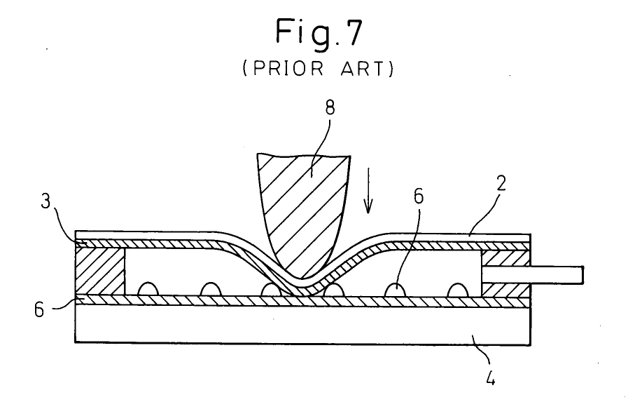

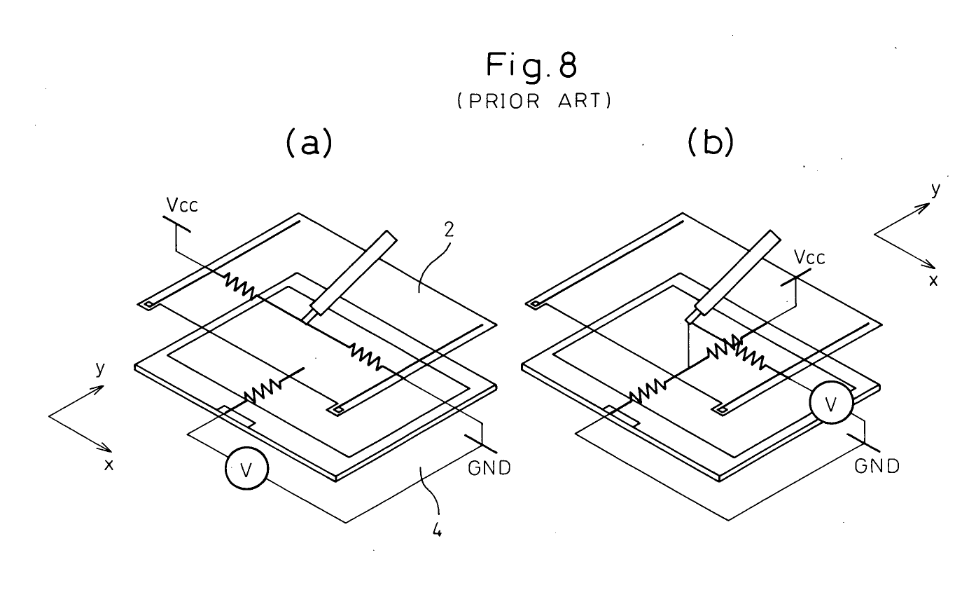

A second embodiment concerns a configuration that uses a circularly polarizing plate as the polarizing plate. FIG. 5 is a schematic cross-sectional view of a resistive film type touch panel that uses the circularly polarizing plate according to the present invention. In the figure, the same reference numerals as those used in the description of the prior art are used to designate the same component elements. In FIG. 5, reference numeral 1 indicates the touch panel, and 3 the transparent electrode which is formed from an electrically conductive polymer. Further, reference numeral 4 indicates the glass substrate, 5 the spacers, and 6 the transparent electrically conductive film made of ITO. Reference numeral 7 indicates the double-sided adhesive tape, and 8 the polarizing plate, while reference numeral 9 indicates a λ/4 plate (phase retardation plate).

The λ/4 plate 9 does not absorb light, but changes only the phase; this is a birefringence device that introduces a phase difference of π/2 (90°) between orthogonally polarized components, and that converts linearly polarized light into circularly or elliptically polarized light or converts circularly polarized light into linearly polarized light. The coating layer 12 is formed to protect the interior of the panel, and has a thickness of 3 μm to 4 μm.

The λ/4 plate 9 can be fabricated by first depositing polycarbonate (PC) or polyvinyl alcohol (PVA) as the material in the form of a film by solvent casting, and then uniaxially stretching the film. In the second embodiment, after the λ/4 plate is coated on one surface thereof with the electrically conductive polymer by the previously described method (using a roll coater, gravure coater, bar coater, spray coater, screen printing, or the like), the λ/4 plate is bonded to the polarizing film. As an alternative method, the film made of the above material (PC or PVA) may first be coated with the electrically conductive polymer 3 and then uniaxially stretched to produce the phase retardation plate having the electrically conductive polymer film formed thereon (3, 9), and the thus produced phase retardation plate may be bonded to the polarizing plate 8 to fabricate the upper transparent substrate. Such processing is not possible with ITO which is a brittle material.

Finally, the film (8, 9, 3) and the glass substrate 4 with the ITO layer 6 and the dot spacers 5 formed thereon are bonded together along their outer edges by the double-side adhesive tape 7, to complete the construction of the panel.

According to the present invention, the upper transparent substrate of the touch panel can be fabricated in a simple process that involves applying a transparent electrically conductive polymer; since this process can be accomplished by continuous processing in the atmosphere, the production cost, the time required for the production, and the complexity of the production can be greatly reduced. Further, since the polarizing plate coated with the electrically conductive polymer is flexible and resistant to repeated bending, the life of the touch panel can be greatly increased. Furthermore, the manufacturing process is simplified as the PET film used in the prior art is omitted. Since touch panels of the resistive film type are currently in widespread use, it is apparent that the industrial applicability of the touch panel of the present invention is enormous.

Although the above embodiments have been described as exemplary embodiments of the invention, it should be understood that additional modifications, substitutions, and changes may be made to the above system without departing from the scope of the invention as disclosed herein. Accordingly, the scope of the invention is by no means restricted by the specific embodiments described herein, but should be defined by the appended claims and their equivalents.

1. A touch panel constructed such that a transparent substrate coated with a transparent electrically conductive polymer and having dot spacers formed on top thereof, and a polarizing plate coated with a transparent electrically conductive polymer on a side thereof facing said transparent substrate, are disposed opposite each other with a prescribed space provided therebetween.

2. A touch panel as claimed in claim 1, wherein said polarizing plate includes a phase retardation plate coated with a transparent electrically conductive polymer.

3. A touch panel manufacturing process comprising the step of fabricating an upper transparent substrate by coating a polarizing plate with a transparent electrically conductive polymer.

4. A touch panel manufacturing process comprising the steps of:
coating a protective film with an electrically conductive polymer; and fabricating an upper transparent substrate by bonding said electrically conductive polymer-coated protective film, a polarizing film, and a protective film which is different from said polymer-coated protective film, one on top of another.

5. A touch panel manufacturing process as claimed in claim 3, further comprising the steps of: radiating an excimer laser over a protective film surface on which said electrically conductive polymer is to be applied by printing; and applying a coating of said electrically conductive polymer.

6. A touch panel manufacturing process as claimed in claim 3, further comprising the step of forming an undercoat with binder particles dispersed in a transparent resin, as a base treatment for formation of said electrically conductive polymer.

7. A touch panel manufacturing process as claimed in claim 4, further comprising the steps of: radiating an excimer laser over a protective film surface on which said electrically conductive polymer is to be applied by printing; and applying a coating of said electrically conductive polymer.

8. A touch panel manufacturing process as claimed in claim 4, further comprising the step of forming an undercoat with binder particles dispersed in a transparent resin, as a base treatment for formation of said electrically conductive polymer.
